(19) United States
(12) Patent Application Publication
(10) Pub. No.: US 2023/0103197 A1
(43) Pub. Date: Mar. 30, 2023

(54) METHOD FOR PAGE TURN AND COMPUTING DEVICE FOR EXECUTING THE METHOD

(71) Applicant: VisualCamp Co., Ltd., Seoul (KR)

(72) Inventors: Yun Chan SUK, Seoul (KR); Seong Dong CHOI, Seoul (KR); Se Jong KIM, Gyeonggi-do (KR); Da Bin LEE, Gyeonggi-do (KR)

(21) Appl. No.: 17/908,984

(22) PCT Filed: Jul. 10, 2020
(86) PCT No.: PCT/KR2020/009100

§ 371 Date: Sep. 2, 2022

(30) Foreign Application Priority Data
Mar. 2, 2020 (KR) 10-2020-0026238

(51) Int. Cl. G06F 3/0483; G06F 3/01; G06F 3/04817

(52) U.S. Cl. CPC G06F 3/0483; G06F 3/013; G06F 3/04817

(57) ABSTRACT

A method for page turn according to an embodiment is executed in a computing device which includes one or more processors and a memory storing one or more programs executed by the one or more processors and which displays content including a plurality of pages on a screen. The method includes checking whether a preset page turn icon display event occurs, displaying a page turn icon on the content when the page turn icon display event occurs, and executing the page turn based on a location of a gaze of a user viewing the content on the screen with the gaze of the user tracked.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2020/009100, filed Jul. 10, 2020, which claims priority to the benefit of Korean Patent Application No. 10-2020-0026238 filed in the Korean Intellectual Property Office on Mar. 2, 2020, the entire contents of which are incorporated herein by reference.

### BACKGROUND

### 1. Technical Field

Embodiments of the present disclosure relate to an eye-tracking technology, and more particularly, to a page turn technology using eye-tracking.

### 2. Background Art of the Invention

With more widespread use of mobile phones, more and more users have been consuming content (for example, video content) using the mobile phones. Furthermore, since the mobile phone is equipped with a camera, efforts to apply an eye-tracking technology to various fields are continuing, such as researching a technology for tracking a gaze of a user consuming content through a camera and checking whether the user is paying attention to the content. In recent years, the number of people reading through e-books has been increasing, and in publishing books, more and more have been also published as e-books. Accordingly, there is a need for a method of applying the eye-tracking technology to content that requires a page turn, such as an e-book.

### SUMMARY

Embodiments of the present disclosure is to provide a page turn method capable of executing a page turn through an eye-tracking technology, and a computing device for executing the same.

A method for page turn according to the disclosed embodiment is a method that is executed in a computing device including one or more processors and a memory storing one or more programs executed by the one or more processors, and displaying content including a plurality of pages on a screen, the method including checking whether a preset page turn icon display event occurs; displaying a page turn icon on the content when the page turn icon display event occurs; and executing the page turn based on a location of a gaze of a user viewing the content on the screen with the gaze of the user tracked.

The checking of whether the preset page turn icon display event occurs may include checking whether a preset time elapses based on a point of time when the page turn has occurred.

The preset time may be set based on one or more of a size of characters and the number of characters in text in the content.

The checking of whether the preset page turn icon display event occurs may include checking whether the location of the gaze of the user in a preset direction of a corresponding page reaches a preset location after the point of time when the page turn has occurred.

The preset direction may be a direction perpendicular to a length direction of a line of text on the page.

The checking of whether the preset page turn icon display event occurs may include checking whether the user has read a corresponding page by a preset amount or more after the point of time when the page turn has occurred.

The checking of whether the user has read the page for the preset amount or more may include analyzing a gaze pattern in a first axial direction and a gaze pattern in a second axial direction perpendicular to the first axial direction by tracking the gaze of the user after the point of time when the page turn has occurred; checking whether the user is reading text of a corresponding page based on the gaze pattern in the first axial direction; and checking an amount in which the user has read the page based on the gaze pattern in the second axial direction.

The checking of whether the preset page turn icon display event occurs may include checking whether a first condition is satisfied that a preset time elapses based on a point of time when the page turn has occurred; and checking whether a second condition is satisfied that a location of the gaze of the user in a preset direction of a corresponding page reaches a preset location after the point of time when the page turn has occurred.

The checking of whether the preset page turn icon display event occurs may include checking whether a first condition is satisfied that a preset time elapses based on a point of time when the page turn has occurred; and checking whether a third condition is satisfied that the user has read a corresponding page by a preset amount or after the point of time when the point of time when the page turn has occurred.

The executing of the page turn may further include checking whether the location of the gaze of the user is located within a reaction region set based on a location of the page turn icon.

The reaction region may include a first reaction region set within a preset range based on the location of the page turn icon; and a second reaction region set within a preset range based on an outline of the first reaction region from the outline of first reaction region.

The checking of whether the location of the gaze of the user is located within the reaction region may include checking whether a fixation or a saccade of the gaze of user is located within the first reaction region or checking whether the fixation of the gaze of the user is located within the second reaction region.

The executing of the page turn may further include activating the page turn icon when the location of the gaze of the user is located within the reaction region; and executing the page turn when the gaze of the user gazes at a region of the page turn icon for a preset time.

The executing of the page turn may further include displaying a progress degree of an operation of the page turn in a region of the page turn icon.

The method for page turn may further include canceling the operation of the page turn when the gaze of the user deviates from the region of the page turn icon while executing the page turn.

A method for page turn according to the disclosed embodiment is a method that is executed in a computing device including one or more processors and a memory storing one or more programs executed by the one or more processors, and displaying content including a plurality of pages on a screen, the method including displaying a page turn icon on the content; checking whether a location of a gaze of a user viewing the content on the screen is located within a reaction region set based on a location of the page turn icon; activating the page turn icon when the location of the gaze of the user is located within the reaction region; and executing the page turn when the gaze of the user gazes at a region of the page turn icon for a preset time.

A computing device according to the disclosed embodiment is a computing device configured to include one or more processors, a memory. and one or more programs, the one or more programs being stored in the memory and be executed by the one or more processors, and displaying content including a plurality of pages on a screen, the one or more programs including a command for checking whether a preset page turn icon display event occurs, a command for displaying a page turn icon on the content when the page turn icon display event occurs, and a command for executing the page turn based on a location of a gaze of a user viewing the content on the screen with the gaze of the user tracked.

A computing device according to another disclosed embodiment is a computing device configured to include one or more processors, a memory. and one or more programs, the one or more programs being stored in the memory and be executed by the one or more processors, and displaying content including a plurality of pages on a screen, the one or more programs including a command for displaying a page turn icon in the content; a command for checking a location of a gaze of a user viewing the content on the screen is located within a reaction region set based on a location of the page turn icon; a command for activating the page turn icon when the location of the gaze of the user is located within the reaction region; and a command for executing the page turn when the gaze of the user gazes at a region of the page turn icon for a preset time.

According to the disclosed embodiments, it is possible for the user to execute a page turn through a gaze while viewing content including a plurality of pages on a screen, thereby improving user convenience.

### BRIEF DESCRIPTION OF THE DRAWINGS

FIG. 1 is a block diagram exemplarily illustrating a computing environment that includes a computing device suitable for use in embodiments of the present disclosure.

FIG. 2 is a flowchart illustrating a page turn method using eye-tracking according to an embodiment of the present disclosure.

FIG. 3 is a graph illustrating a gaze pattern in a first axial direction and a gaze pattern in a second axial direction, of a user, according to an embodiment of the present disclosure.

FIG. 4 is a view illustrating a state of displaying a page turn icon in content according to an embodiment of the present disclosure.

FIG. 5 is a view illustrating another embodiment of the page turn icon according to the present disclosure.

FIG. 6 is a view illustrating a reaction region according to an embodiment of the present disclosure.

FIG. 7 is a view illustrating a state in which the page turn icon is activated according to an embodiment of the present disclosure.

FIG. 8 is a view illustrating an activation display of a page turn icon according to another embodiment of the present disclosure.

FIG. 9 is a view illustrating a state in which the page turn is executed according to an embodiment of the present disclosure.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of a known technology related to the present disclosure may unnecessarily obscure the gist of the present disclosure, the detailed descriptions thereof will be omitted. The terms used below are defined in consideration of functions in the present disclosure, but may be changed depending on the customary practice or the intention of a user or operator. Thus, the definitions should be determined based on the overall content of the present specification. The terms used herein are only for describing the embodiments of the present disclosure, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

In the following description, the terminology “transmission”, “communication”, “reception” of a signal or information and terminology similar thereto may include a meaning in which the signal or information is directly transmitted from one element to another element and transmitted from one element to another element through an intervening element. In particular, “transmission” or “sending” of the signal or information to one element may indicate a final destination of the signal or information and may not imply a direct destination. The same is true for “reception” of the signal or information. In addition, in the present specification, a meaning in which two or more pieces of data or information are “related” indicates that when any one piece of data (or information) is obtained, at least a portion of other data (or information) may be obtained based thereon.

Meanwhile, directional terms such as top, bottom, one side, the other side, and the like, are used in connection with orientations of the disclosed figures. Since components of embodiments of the present disclosure can be positioned in various orientations, the directional terminology is used for purposes of illustration and not limitation.

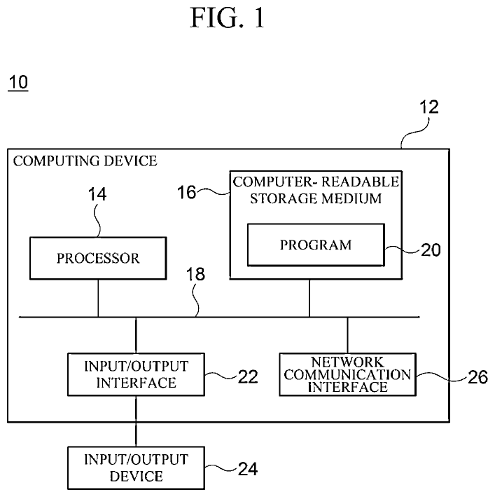

FIG. 1 is a block diagram exemplarily illustrating a computing environment 10 that includes a computing device suitable for use in exemplary embodiments. In the illustrated embodiment, each component may have a different function and capability in addition to those described below, and additional components may be included in addition to those described below.

The illustrated computing environment 10 includes a computing device 12. In an embodiment, the computing device 12 may be a device for executing a page turn method using eye-tracking according to an embodiment of the present disclosure.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as a component constituting the computing device 12, or may be connected to the computing device 12 as a separate device distinct from the computing device 12.

An application for executing the page turn using eye-tracking may be installed in the computing device 12. The application may be stored in a computer-readable storage medium 16. The application includes a predetermined set of instructions executable by the processor 14. The instructions may cause the processor 14 to perform operations in accordance with an exemplary embodiment. The computer-readable storage medium 16 includes components of an operating system for executing a set of instructions, such as the application, on the computing device 12. For example, the operating system may be Apple's iOS or Google's Android.

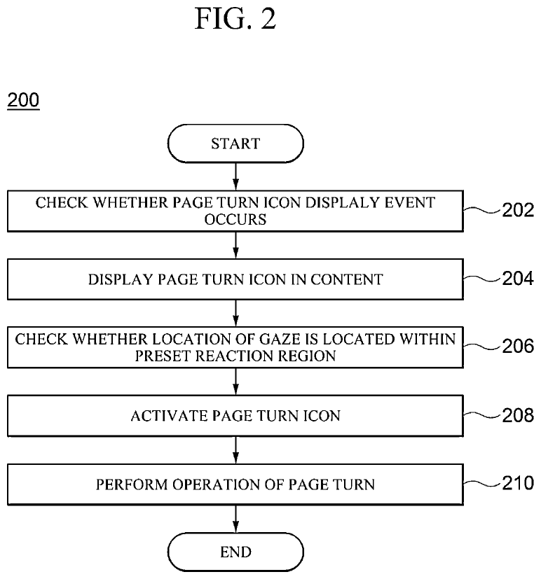

FIG. 2 is a flowchart illustrating a page turn method using eye-tracking according to an embodiment of the present disclosure. As described above, a method 200 according to an embodiment of the present disclosure may be executed by a computing device 12 including one or more processors, and a memory storing one or more programs executed by the one or more processors. To this end, the method 200 may be implemented in the form of a program or software including one or more computer-executable instructions and stored in the memory.

Further, in the illustrated flowchart, the method is divided into a plurality of steps; however, at least some of the steps may be performed in a different order, performed together in combination with other steps, omitted, performed in subdivided steps, or performed by adding one or more steps not shown.

Here, the computing device 12 may display content including a plurality of pages on the screen. In an exemplary embodiment, the computing device 12 may be a smartphone, a tablet PC, an e-book reader, or the like, but is not limited thereto. The content including a plurality of pages may refer to content that requires a page turn without displaying the entire content on the screen of the computing device 12. That is, the content including a plurality of pages may be content in a form in which the next page is displayed on the screen of the computing device 12 through the page turn.

In this case, the page turn may be a method of turning sideways or a method of scrolling up and down, but is not limited thereto. In addition, the content may consist of text, but is not limited thereto, and may be a mixture of text and images (videos, images, or the like). Hereinafter, a process from a point of time when one page turn has occurred in content until the next page turn is executed will be described. For convenience of description, the content will be described as being an e-book as an example.

In step 202, the computing device 12 checks whether a preset page turn icon display event occurs. In an exemplary embodiment, the page turn icon display event may occur with the lapse of a preset time based on a point of time when the page turn has occurred. For example, the computing device 12 may determine that the page turn icon display event occurs when five seconds elapse from the point of time when the page turn has occurred.

Here, the elapsed time for the page turn icon display event may be set based on one or more of the size of characters and the number of characters in text in the content. For example, as the size of characters in the text is larger, the elapsed time may be set to be shorter. In addition, as the number of characters in the text is greater, the elapsed time may be set to be longer.

In addition, the page turn icon display event may occur when the location of the gaze of the user in a preset direction of a corresponding page reaches a preset location after the point of time when the page turn has occurred. Here, assuming that a length direction of a line of text in the page is a first axial direction (e.g., an x-axis direction), the preset direction may be a second axial direction (e.g., a y-axis direction) perpendicular to the first axial direction. The computing device 12 may track the gaze of the user after a point of time when the page turn has occurred, and determine that the page turn icon display event occurs when the location of the gaze of user reaches a preset location in the second axial direction.

In addition, the page turn icon display event may occur when the user has read the page by a preset amount or more after the point of time when the page turn has occurred. The computing device 12 may check whether the user has read the page by a preset amount or more by tracking the gaze of the user.

In an exemplary embodiment, the computing device 12 may analyze a gaze pattern in the first axial direction and a gaze pattern in the second axial direction by tracking the gaze of the user after the point of time when the page turn has occurred, and may check whether the user has read the page by the preset amount or more based on the gaze pattern in the first axial direction and the gaze pattern in the second axial direction. The computing device 12 may check whether the user is reading text of the page through the gaze pattern in the first axial direction (i.e., the length direction of the line in the text), and may check how much the user has read the page through the gaze pattern in the second axial direction.

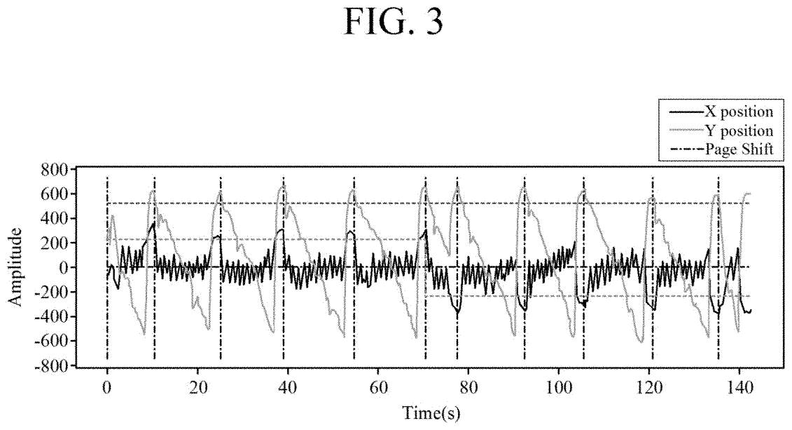

FIG. 3 is a graph illustrating the gaze pattern in the first axial direction and the gaze pattern in the second axial direction, of the user, according to an embodiment of the present disclosure. As illustrated in FIG. 3, when the user reads the text of the page well, it can be seen that the gaze pattern in the first axial direction (x-axis direction) moves in a zigzag manner. In addition, it can be seen that the gaze pattern in the second axial direction (y-axis direction) moves downward (gaze movement for reading by changing text lines) and then suddenly moving upward (gaze movement for the page turn).

In addition, the page turn icon display event may occur when a first condition is satisfied that the preset time elapses based on the point of time when the page turn has occurred, and a second condition is satisfied that the location of the gaze of the user in a preset direction of the page reaches a preset location after the point of time when the page turn has occurred. In addition, the page turn icon display event may occur when the first condition is satisfied that the preset time elapses based on the point of time when the page turn has occurred, and a third condition is satisfied that the user has read the page by a preset amount or more after the point of time when the page turn has occurred.

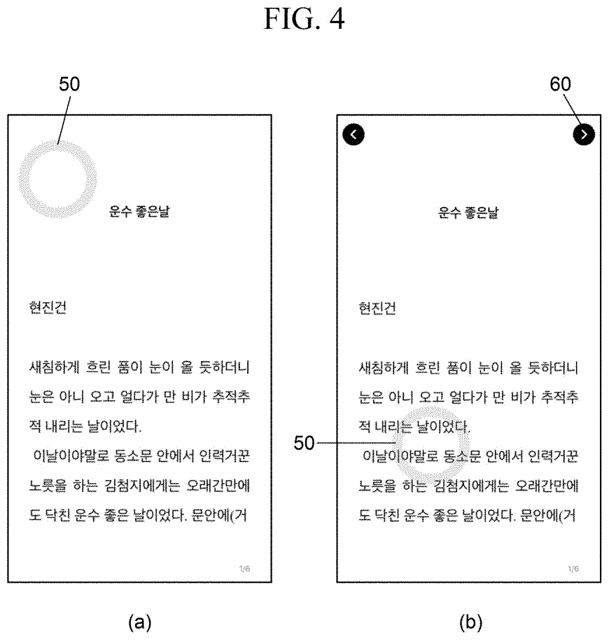

In step 204, when the preset page turn icon display event occurs, the computing device 12 displays a page turn icon in the content. FIG. 4 is a view illustrating a state of displaying a page turn icon in content according to an embodiment of the present disclosure.

(a) of FIG. 4 is a screen showing content in a state in which a page turn has occurred. Here, the content is a novel as an e-book. When a page turn occurs, the computing device 12 may display a gaze location icon 50 on the content screen by tracking the gaze of the user. That is, the computing device 12 may display the location of the gaze of the user within the content through the gaze location icon 50. The gaze location icon 50 may be displayed in a ring shape, but is not limited thereto.

(b) of FIG. 4 shows a state in which a page turn icon display event occurs and a page turn icon 60 is displayed in the content. Here, it is assumed that the page turn icon display event occurs when the location of the gaze of the user (i.e., the gaze location icon 50) reaches a preset location in a preset direction (i.e., the y-axis direction) of a corresponding page.

Although the page turn icon 60 is illustrated as being displayed on each upper corner of the page, the displayed location is not limited thereto. In addition, although the page turn icon 60 is illustrated as having an arrow displayed in a page turning direction within the background of a black circle, the page turn icon 60 is not limited thereto, and may be displayed in various other forms.

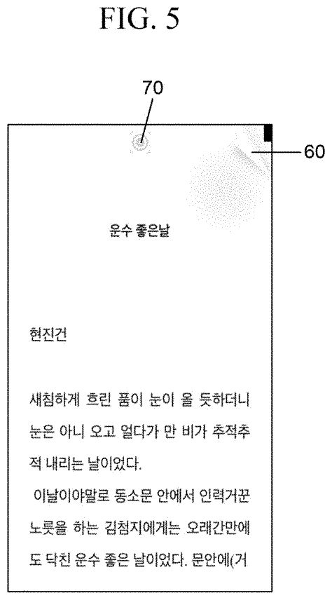

FIG. 5 is a view illustrating another embodiment of the page turn icon 60 according to the present disclosure. Referring to FIG. 5, the page turn icon 60 may be displayed in a state in which the upper edge of the page is folded. In addition, the computing device 12 may display an eye-tracking mark 70 on the page. The eye-tracking mark 70 may indicate that the gaze of the user is being tracked.

In step 206, the computing device 12 checks whether the location of the gaze of the user is located within a preset reaction region on the page. Here, a predetermined range of the preset reaction region may be set based on a point at which the page turn icon 60 is displayed. That is, the preset reaction region may be a region for checking whether the user finishes reading the page and moves the gaze of the user toward the page turn icon 60 for the page turn.

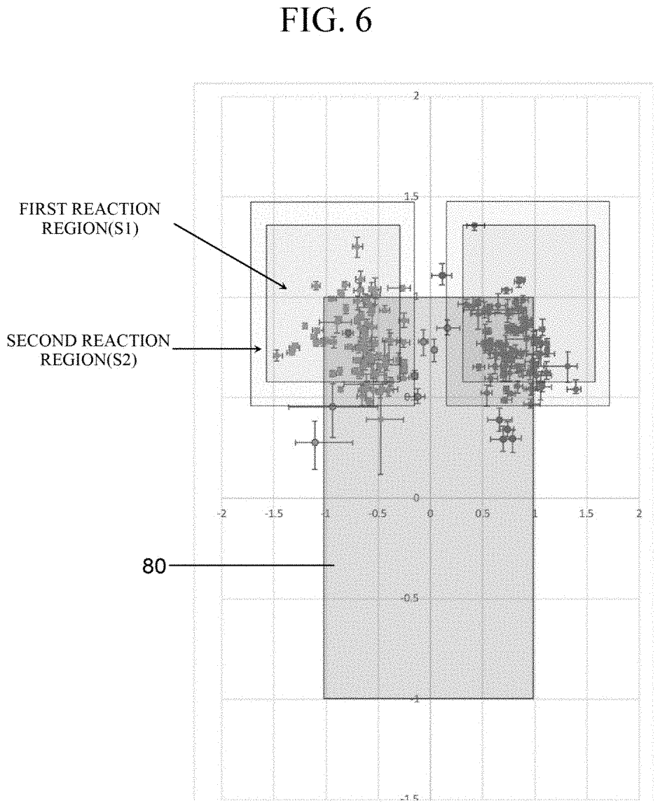

FIG. 6 is a view illustrating a reaction region according to an embodiment of the present disclosure. Referring to FIG. 6, the reaction region may include a first reaction region S1 and a second reaction region S2. The first reaction region S1 may be set within a preset range based on the location of the page turn icon 60. Here, the first reaction region S1 may also include a region outside a screen range 80 of the computing device 12. The second reaction region S2 may be set within a preset range based on an outline of the first reaction region S1 from the outline of the first reaction region S1.

The computing device 12 may check whether a fixation or a saccade of the gaze of the user is located in the first reaction region S1. Alternatively, the computing device 12 may check whether the fixation of the gaze of the user is located within the second reaction region S2.

Here, the saccade is an eye movement in which both eyes move rapidly in the same direction at the same time, which occurs between fixations, and typically lasts 20 to 40 ms. The saccade is mainly used to direct the gaze towards an object of interest. In addition, fixation refers to maintaining the gaze at a single location, and may mean that the gaze is fixed. The fixation may typically last 50 to 600 ms.

In step 208, when the location of the gaze of the user is located within a preset reaction region on the page, the computing device 12 activates the page turn icon 60. That is, when the location of the gaze of the user is located within a preset reaction region on the page, the page turn icon 60 may be activated as a preparatory operation for the page turn.

Here, the computing device 12 activates the page turn icon 60 when a fixation or a saccade a of the gaze of the user is located in the first reaction region S1. Alternatively, when a fixation of the gaze of the user is located within the second reaction region S2, the computing device 12 activates the page turn icon 60.

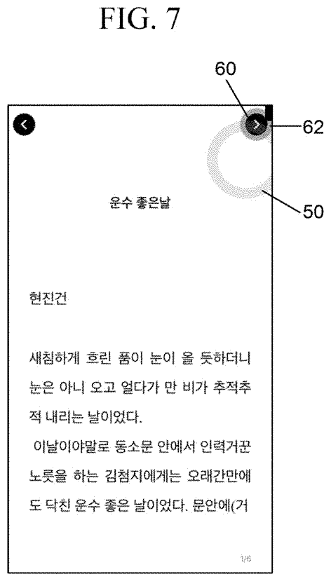

FIG. 7 is a view illustrating a state in which the page turn icon 60 is activated according to an embodiment of the present disclosure. In FIG. 7, when the gaze location icon 50 is located within the preset reaction region, a boundary of the page turn icon 60 is displayed in green to indicate that the page turn icon 60 is activated (62). However, the activation display 62 of the page turn icon 60 is not limited thereto, and the activation display may have various other forms.

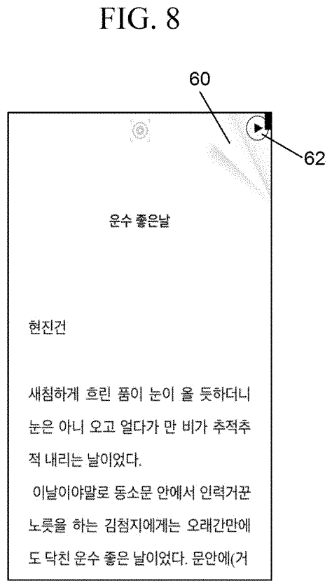

FIG. 8 is a view illustrating an activation display 62 of a page turn icon 60 according to another embodiment of the present disclosure. Referring to FIG. 8, the page turn icon 60 may be displayed in a state in which the upper edge of a corresponding page is folded. In addition, the activation display 62 may be displayed as having an arrow in a circle at the upper edge of the page.

In step 210, the computing device 12 executes a page turn operation when the gaze of the user gazes at a region of the page turn icon 60 for a preset time. That is, when the user gazes at the region of the page turn icon 60 for a preset time, the computing device 12 may recognize the gaze as a user command for page turn and perform the operation of turning the page to the next page.

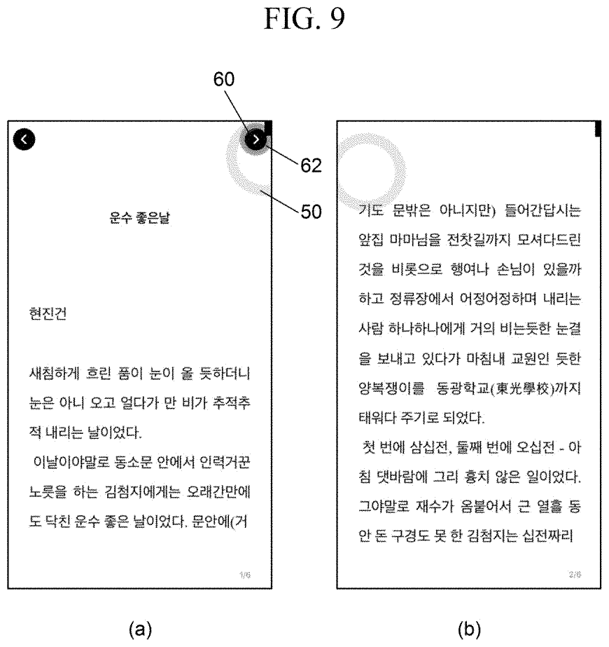

FIG. 9 is a view illustrating a state in which the page turn is executed according to an embodiment of the present disclosure. Referring to (a) of FIG. 9, the computing device 12 may execute the page turn operation when the gaze of the user gazes at the region of the page turn icon 60 for a preset time. In this case, the computing device 12 may display a progress degree 64 of the page turn operation on the region of the page turn icon 60. For example, the computing device 12 may display the progress degree 64 of the page turn operation along the boundary of page turn icon 60. The computing device 12 may display the progress degree of the page turn icon 60 along the boundary of the page turn icon 60 with the degree to which the page turn operation is performed.

Referring to (b) of FIG. 9, when the page turn operation is completed, the computing device 12 may display the next page of the content on the screen.

Meanwhile, the computing device 12 may cancel the page turn operation when the gaze of the user deviates from the region of the page turn icon 60 while the page turn operation is being performed.

According to the disclosed embodiments, it is possible for the user to execute the page turn through the gaze while viewing the content including a plurality of pages on the screen, thereby improving user convenience.

Although the representative embodiments of the present disclosure have been described in detail as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

1: A method for page turn that is executed in a computing device including one or more processors and a memory storing one or more programs executed by the one or more processors, the computing device configured for displaying content including a plurality of pages on a screen, the method comprising:
checking whether a preset page turn icon display event occurs;
displaying a page turn icon on the content when the page turn icon display event occurs; and
executing the page turn based on a location of a gaze of a user viewing the content on the screen with the gaze of the user tracked.

2: The method of claim 1, wherein the checking of whether the preset page turn icon display event occurs includes checking whether a preset time elapses based on a point of time when the page turn has occurred.

3: The method of claim 2, wherein the preset time is set based on one or more of a size of characters and the number of characters in text in the content.

4: The method of claim 1, wherein the checking of whether the preset page turn icon display event occurs includes checking whether the location of the gaze of the user in a preset direction of a corresponding page reaches a preset location after a point of time when the page turn has occurred.

5: The method of claim 4, wherein the preset direction is a direction perpendicular to a length direction of a line of text on the page.

6: The method of claim 1, wherein the checking of whether the preset page turn icon display event occurs includes checking whether the user has read a corresponding page by a preset amount or more after a point of time when the page turn has occurred.

7: The method of claim 6, wherein the checking of whether the user has read the page for the preset amount or more includes:
analyzing a gaze pattern in a first axial direction and a gaze pattern in a second axial direction perpendicular to the first axial direction by tracking the gaze of the user after the point of time when the page turn has occurred;
checking whether the user is reading text of a corresponding page based on the gaze pattern in the first axial direction; and
checking an amount in which the user has read the page based on the gaze pattern in the second axial direction.

8: The method of claim 1, wherein the checking of whether the preset page turn icon display event occurs includes:
checking whether a first condition is satisfied that a preset time elapses based on a point of time when the page turn has occurred; and
checking whether a second condition is satisfied that a location of the gaze of the user in a preset direction of a corresponding page reaches a preset location after the point of time when the page turn has occurred.

9: The method of claim 1, wherein the checking of whether the preset page turn icon display event occurs includes:
checking whether a first condition is satisfied that a preset time elapses based on a point of time when the page turn has occurred; and
checking whether a third condition is satisfied that the user has read a corresponding page by a preset amount or after a point of time when the page turn has occurred.

10: The method of claim 1, wherein the executing of the page turn further includes checking whether the location of the gaze of the user is located within a reaction region set based on a location of the page turn icon.

11: The method of claim 10, wherein the reaction region includes:
a first reaction region set within a preset range based on the location of the page turn icon; and
a second reaction region set within a preset range based on an outline of the first reaction region from the outline of the first reaction region.

12: The method of claim 11, wherein the checking of whether the location of the gaze of the user is located within the reaction region includes checking whether a fixation or a saccade of the gaze of the user is located within the first reaction region or checking whether the fixation of the gaze of the user is located within the second reaction region.

13: The method of claim 10, wherein the executing of the page turn further includes:
activating the page turn icon when the location of the gaze of the user is located within the reaction region; and
executing the page turn when the gaze of the user gazes at a region of the page turn icon for a preset time.

14: The method of claim 13, wherein the executing of the page turn further includes displaying a progress degree of an operation of the page turn in the region of the page turn icon.

15: The method of claim 13, further comprising:
canceling the operation of the page turn when the gaze of the user deviates from the region of the page turn icon while executing the page turn.

16: A method for page turn that is executed in a computing device including one or more processors and a memory storing one or more programs executed by the one or more processors, the computing device configured for displaying content including a plurality of pages on a screen, the method comprising:
displaying a page turn icon on the content;
checking whether a location of a gaze of a user viewing the content on the screen is located within a reaction region set based on a location of the page turn icon;
activating the page turn icon when the location of the gaze of the user is located within the reaction region; and
executing the page turn when the gaze of the user gazes at the region of the page turn icon for a preset time.

17: A computing device configured to include one or more processors, a memory, and one or more programs, the one or more programs being stored in the memory and be executed by the one or more processors, and displaying content including a plurality of pages on a screen, the one or more programs comprising:
a command for checking whether a preset page turn icon display event occurs;
a command for displaying a page turn icon on the content when the page turn icon display event occurs; and
a command for executing the page turn based on a location of a gaze of a user viewing the content on the screen with the gaze of the user tracked.

18. (canceled)
